(19) United States
(12) Patent Application Publication
(10) Pub. No.: US 2017/0064747 A1
(43) Pub. Date: Mar. 2, 2017

(54) METHOD OF PAIRING VEHICULAR TERMINAL AND USER TERMINAL BY USING BEACON AND VEHICULAR TERMINAL

(71) Applicant: MTOV INC., Daejeon (KR)

(72) Inventors: Sangsu JUNG, Uiwang-si (KR); Youngsam KIM, Daejeon (KR); Jongwoo CHOI, Daejeon (KR)

(21) Appl. No.: 15/350,107

(22) Filed: Nov. 14, 2016

Related U.S. Application Data
(63) Continuation of application No. PCT/KR2015/011227, filed on Oct. 22, 2015.

(30) Foreign Application Priority Data
May 21, 2015 (KR) 10-2015-0070920

(51) Int. Cl. H04W 76/02; G07C 5/00; H04W 12/06; H04W 8/00; H04W 12/04

(52) U.S. Cl. CPC H04W 76/02; H04W 8/005; H04W 12/04; H04W 12/06; G07C 5/008; H04W 84/18

(57) ABSTRACT

Disclosed are a method of pairing a vehicular terminal and a user terminal by using Beacon and a vehicular terminal. The method of pairing a vehicular terminal and a user terminal by using Beacon by the user terminal includes receiving a Beacon message from the vehicular terminal, searching for a service corresponding to the received Beacon message, displaying an object regarding the found service on a screen, and if the object is selected by a user, initiating pairing of the vehicular terminal and the user terminal.

### CROSS-REFERENCE TO RELATED APPLICATIONS

The present application is a continuation of International Patent Application No. PCT/KR2015/011227, filed Oct. 22, 2015, which is based upon and claims the benefit of priority to Korea Patent Application No. 10-2015-0070920, filed on May 21, 2015. The disclosures of the above-listed applications are hereby incorporated by reference herein in their entirety.

### BACKGROUND

Embodiments of the inventive concept described herein relate to Beacon, and more particularly to a method of pairing a vehicular terminal and a user terminal by using Beacon and a vehicular terminal.

Beacon refers to a communication technology or device that periodically transmits a signal to a specific location or space. Because an available distance of Beacon is longer than that of a near field communication (NFC) scheme, Beacon is suitable for an O2O service that connects online and offline. By using Beacon, data may be transmitted at a site having a specific radius. Further, Beacon may be used to collect location information while replacing a GPS in the interior of a building.

### SUMMARY

Embodiments of the inventive concept provide a method of pairing a vehicular terminal and a user terminal by using Beacon.

Embodiments of the inventive concept also provide a vehicular terminal paired with a user terminal by using Beacon.

The technical objects of the inventive concept are not limited to the above-mentioned ones, and the other unmentioned technical objects will become apparent to those skilled in the art from the following description.

In accordance with an aspect of the inventive concept, there is provided a method of pairing a vehicular terminal and a user terminal by using Beacon by the user terminal, the method including receiving a Beacon message from the vehicular terminal, searching for a service corresponding to the received Beacon message, displaying an object regarding the found service on a screen, and if the object is selected by a user, initiating pairing of the vehicular terminal and the user terminal.

In accordance with another aspect of the inventive concept, there is provided a vehicular terminal including a wireless communication unit that wirelessly communicates with a user terminal, an output unit that notifies a user of information, and a control unit that controls the wireless communication unit and the output unit to pair the vehicular terminal and the user terminal, and the pairing of the vehicular terminal and the user terminal may include transmitting a Beacon message to the user terminal, receiving a request for pairing from the user terminal, exchanging public keys with the user terminal, and notifying the user of a public key authentication value.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating a system including a vehicular terminal and a user terminal according to an embodiment of the inventive concept;

FIG. 2 is a block diagram schematically illustrating a detailed configuration of the vehicular terminal of FIG. 1 according to an embodiment of the inventive concept;

FIG. 3 is a block diagram schematically illustrating a detailed configuration of the user terminal of FIG. 1;

FIG. 4 is a flowchart schematically illustrating an identification process of the method of pairing a vehicular terminal and a user terminal according to an embodiment of the inventive concept;

FIG. 5 is a view schematically illustrating an object displayed on a screen of the user terminal; and

FIG. 6 is a flowchart schematically illustrating a pairing process of the method of pairing a vehicular terminal and a user terminal according to an embodiment of the inventive concept.

### DETAILED DESCRIPTION

Hereinafter, exemplary embodiments of the inventive concept will be described in detail with reference to the accompanying drawings. The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept is provided to make the disclosure of the inventive concept complete and fully inform those skilled in the art to which the inventive concept pertains of the scope of the inventive concept. The same reference numerals denote the same elements throughout the specification.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements.

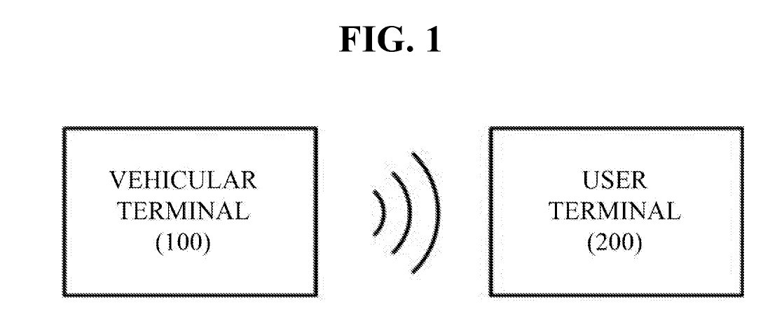

FIG. 1 is a block diagram schematically illustrating a system including a vehicular terminal and a user terminal according to an embodiment of the inventive concept.

Referring to FIG. 1, the vehicular terminal 100 may transmit a Beacon message to the user terminal 200. The user terminal 200 may receive the Beacon message from the vehicular terminal 100, and may be paired with the vehicular terminal 100 in response to the received Beacon message.

The vehicular terminal 100, for example, is an on-board diagnostics (OBD) device that collects, analyzes, and stores travel data of a vehicle, but the inventive concept is not limited thereto. The vehicle terminal 100 may be installed in a dashboard, a hood, a center fascia, or a console box.

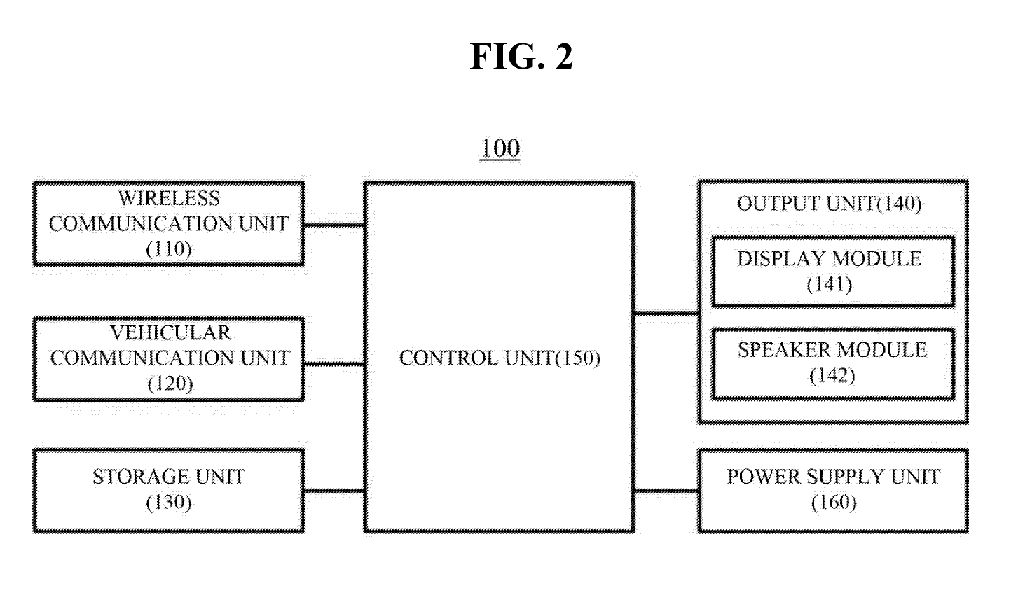

FIG. 2 is a block diagram schematically illustrating a detailed configuration of the vehicular terminal of FIG. 1 according to an embodiment of the inventive concept.

Referring to FIG. 2, the vehicular terminal 100 includes a wireless communication unit 110, a vehicular communication unit 120, a storage unit 130, an output unit 140, a control unit 150, and a power supply unit 160.

The wireless communication unit 110 wirelessly communicates with the user terminal 200. In some embodiments, the wireless communication unit 110 wirelessly communicates with the user terminal 200 by using a short range wireless communication scheme such as Bluetooth, but the wireless communication scheme is not limited thereto. The wireless communication unit 110 may use various other wireless communication schemes, such as radio frequency (RF), ultrasonic waves, infrared rays, mobile communication, Wi-Fi, ZigBee, and Wibro. The wireless communication unit 110 delivers information and/or data received from the user terminal 200 to the control unit 160, and transmits information and/or data delivered from the control unit 160 to the user terminal 200. In some embodiments, the wireless communication unit 110 includes a network interface card or a wireless transceiver.

In some embodiments, the wireless communication unit 110 transmits a Beacon message to the user terminal 200 that is adjacent to the vehicular terminal 100. In some embodiments, the wireless communication unit 110 transmits a Beacon message at a predetermined cycle. The wireless communication unit 110 may transmit a Beacon message in various transmission schemes and forms, such as Bluetooth Beacon, RF Beacon, ultrasonic Beacon, optical Beacon, and Wi-Fi Beacon.

The vehicular communication unit 120 communicates with elements (for example, an electronic control unit (ECU), various sensors, and various driving units) in the vehicle. The vehicular communication unit 120 may communicate with the elements in the vehicle by using a communication scheme such as a controller area network (CAN), but the communication scheme is not limited thereto.

The storage unit 130 stores various data and instructions. In some embodiments, the storage unit 130 stores a program for an operation of the vehicular terminal 100. The storage unit 130 may include a random access memory (RAM), a read only memory (ROM), an erasable programmable ROM (EPROM), an electrically erasable programmable ROM (EEPROM), a flash memory, a hard disk, a detachable disk, or a computer readable recording medium in an arbitrary form, which is well known in the art to which the inventive concept pertains.

The output unit 140 notifies the user of various pieces of information. The output unit 140 outputs information in the form of a text, an image, a voice, or a frequency signal.

In some embodiments, to achieve this, the output unit 140 may include a display module 141 and a speaker module 142. The output unit 140 may further include an output unit that is well known in the art to which the inventive concept pertains. The display module 141 is provided in the form such as a plasma display panel (PDP), a liquid crystal display (LCD), a thin film transistor (TFT) LCD, an organic light emitting diode, a flexible display, a 3D display, or an e-ink display, or a form that are well known in the art to which the inventive concept pertains. The speaker module 142 stores various voice signal in advance, and outputs a specific voice signal based on data or instructions received from the control unit 160. Further, the speaker module 142 encodes the data received from the control unit 160 and outputs a frequency signal having a specific range of frequencies. As will be described below, in some embodiments, the output unit 140 notifies the user of information that will be transmitted to the user terminal 200, and allows the user to input corresponding information to the user terminal 200. The information that requires security is delivered to the user terminal 200 in this scheme. In an aspect that information is delivered by using a separate channel instead of using a wireless communication channel, the output unit 140 may be defined as an out-of-band (00B) communication unit.

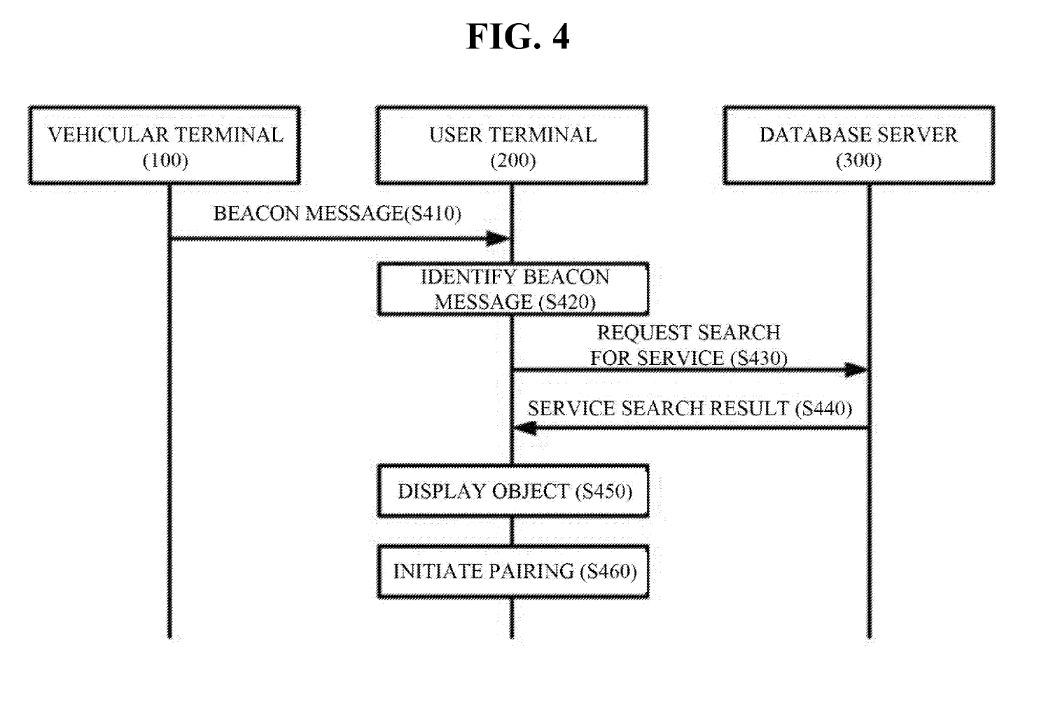

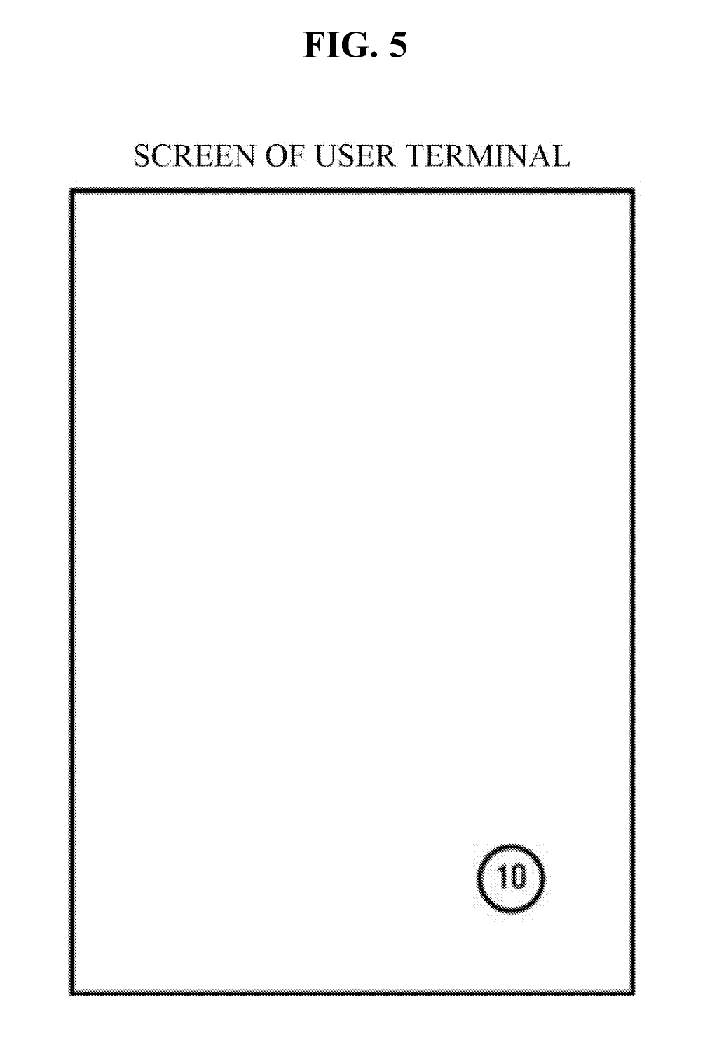

The control unit 150 controls an overall operation of the vehicular terminal 100 by controlling other elements. In some embodiments, the controller 150 performs an operation of pairing the vehicular terminal 100 and the user terminal 200 by controlling the wireless communication unit 110 and the output unit 140. The pairing operation of the control unit 150 will be described in more detail with reference to FIGS. 4 and 5.

The power supply unit 160 supplies electric power that is necessary for operations of the wireless communication unit 110, the vehicular communication unit 120, the storage unit 130, the output unit 140, and the control unit 150. In some embodiments, the power supply unit 160 receives electric power from the vehicle or includes an embedded battery.

Meanwhile, the elements of FIG. 2 are not inevitably necessary, and the vehicular terminal 100 may include a larger number of elements or a smaller number of elements.

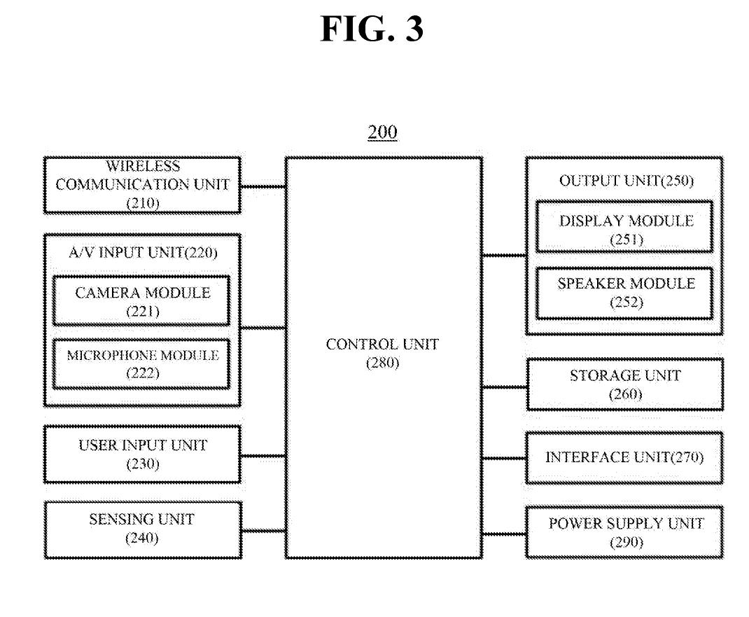

FIG. 3 is a block diagram schematically illustrating a detailed configuration of the user terminal of FIG. 1.

Referring to FIG. 3, the user terminal 200 includes a wireless communication unit 210, an A/V input unit 220, a user input unit 230, a sensing unit 240, an output unit 250, a storage unit 260, an interface unit 270, a control unit 280, and a power supply unit 290.

The wireless communication unit 210 wirelessly communicates with an external device (the vehicular terminal 100 in the embodiment of the inventive concept). The wireless communication unit 210 may wirelessly communication with an external device by using a wireless communication scheme, such as Bluetooth, RF, ultrasonic waves, infrared rays, mobile communication, Wi-Fi, ZigBee, or Wibro. However, the wireless communication scheme of the user terminal 200 is not limited thereto. In some embodiments, the wireless communication unit 210 delivers information and/or data received from the external device to the control unit 280, and transmits the information and/or data delivered from the control unit 280 to the external device. The wireless communication unit 210 may include a network interface card or a wireless transceiver.

The A/V input unit 220 is adapted to input an image, a voice, or a frequency signal, and may include a camera module 221 and a microphone module 222.

The user input unit 230 receives various pieces of information from the user. In some embodiments, the user input unit 230 includes a keypad, a button, a switch, a touchpad, or a jog wheel. When the touch pad forms a mutual layer structure with the display module 251, a touch screen may be constituted.

The sensing unit 240 detects a state of the user terminal 200 or a state of the user. In some embodiments, the sensing unit 240 includes a detection unit such as a touch sensor, a proximity sensor, a pressure sensor, a vibration sensor, a geomagnetic sensor, a gyro sensor, an acceleration sensor, or a biometric sensor. In some embodiments, the sensing unit 240 is used for a user input.

The output unit 250 notifies the user of various pieces of information. The output unit 250 outputs information in the form of a text, an image, a voice, or a frequency signal. In some embodiments, to achieve this, the output unit 250 includes a display module 251 and a speaker module 252. The display module 251 is provided in the form such as a PDP, an LCD, a TFT LCD, an OLED, a flexible display, a 3D display, or an e-ink display, or a form that are well known in the art to which the inventive concept pertains. The output unit 250 may further include an output unit that is well known in the art to which the inventive concept pertains.

The storage unit 260 stores various data and instructions. In some embodiments, the storage unit 260 may store a program for an operation of the user terminal 200. The software module may include an RAM, an ROM, an EPROM, an EEPROM, a flash memory, a register, a hard disk, a detachable disk, or a computer readable recording medium of an arbitrary form that is known in the technical field to which the inventive concept pertains.

The interface unit 270 functions as a passage with an external device connected to the user terminal 200. The interface unit 270 receives data or electric power from an external device to deliver the data or electric power to the elements in the user terminal 200, transmit data in the user terminal 200 to an external device, or supply electric power of the user terminal 200 to an external device. The interface unit 270, for example, includes a wired/wireless headset port, an external charger port, a wired/wireless data port, a memory card port, a port that connects a device provided with an identification module, an audio input/output (I/O) port, or a video input/output (I/O) port.

The control unit 280 controls an overall operation of the user terminal 200 by controlling other elements. In some embodiments, the control unit 280 performs a program for monitoring and processing a Beacon message in a background. In some embodiments, the controller 280 performs an operation of pairing the vehicular terminal 100 and the user terminal 200 by controlling the wireless communication unit 210 and the user input unit 230 (and/or the sensing unit 240 or the output unit 250). The pairing operation of the control unit 280 will be described in more detail with reference to FIGS. 4 and 5.

The power supply unit supplies electric power that is necessary for operations of the wireless communication unit 210, the A/V input unit 220, the user input unit 230, the sensing unit 240, the output unit 250, the storage unit 260, the interface unit 270, and the control unit 280. In some embodiments, the power supply unit 290 receives electric power from the outside or includes an embedded battery.

Meanwhile, the elements of FIG. 3 are not inevitably necessary, and the vehicular terminal 200 may include a larger number of elements or a smaller number of elements.

FIG. 4 is a flowchart schematically illustrating an identification process of the method of pairing a vehicular terminal and a user terminal according to an embodiment of the inventive concept.

Referring to FIG. 4, in operation S410, the vehicular terminal 100 transmits a Beacon message to the user terminal 200 that is adjacent to the vehicular terminal 100.

Next, in operation S420, the user terminal 200 identifies the Beacon message received from the vehicular terminal 100. In some embodiments, the user terminal 200 extracts various pieces of information included in the Beacon message.

Next, the user terminal 200 searches for a service corresponding to the received Beacon message. In some embodiments, in more detail, the user terminal 200 transmits a request for searching for a service to a database server 300 in operation S430, and receives a service search result from the database server 300 in operation S440. In some embodiments, the service search result includes information of a device (that is, the vehicular terminal 100) related to the received Beacon message.

Next, in operation S450, the user terminal 200 displays an object (for example, a text object, a graphic object, or an icon object) regarding a found service. FIG. 5 is a view schematically illustrating an object displayed on a screen of the user terminal. A form, an attribute, and a feature of the object 10 may be variously modified.

Next, in operation S460, if the object is selected by the user, the user terminal 200 starts to be paired with the vehicular terminal 100. If the object is selected by the user, the user terminal 200 may provide a connection management menu for a connection with the vehicular terminal 100. The connection management menu, for example, may include a connection with the vehicular terminal 100 and a disconnection from the vehicular terminal 100. Next, if the user selects a connection with the vehicular terminal 100 from the connection management menu, the user terminal 200 may starts to be paired with the vehicular terminal 100.

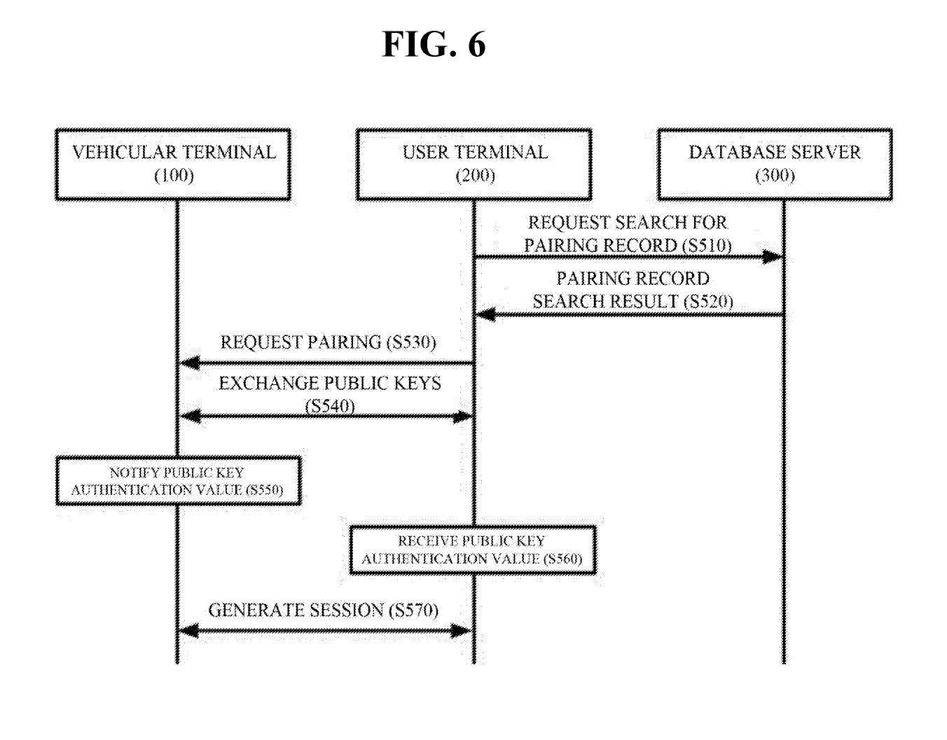

FIG. 6 is a flowchart schematically illustrating a pairing process of the method of pairing a vehicular terminal and a user terminal according to an embodiment of the inventive concept.

Referring to FIG. 6, before pairing is requested, the user terminal 200 searches a pairing record regarding the vehicular terminal 100. In some embodiments, in more detail, the user terminal 200 transmits a request for searching for a pairing record to a database server 300 in operation S510, and receives a pairing record search result from the database server 300 in operation S520.

Next, in operation S530, if there is no pairing record regarding the vehicular terminal 100, the user terminal 200 may transmit a request for pairing to the vehicular terminal 100.

Next, in operation S540, the vehicular terminal 100 that received the pairing request from the user terminal 200 transmits a public key to the user terminal 200 and the user terminal 200 also transmits a public key to the vehicular terminal 100 so that the vehicular terminal 100 and the user terminal 200 exchanges public keys.

Next, in operation S550, the vehicular terminal 100 notifies the user of a public key authentication value. In some embodiments, the vehicular terminal 100 outputs a public key authentication value in the form of a text, an image, a voice, or a frequency signal such that the user may identify the public key authentication value. In some embodiments, the public key authentication value includes a letter, a number, a symbol, or a combination thereof.

Next, in operation S560, the user terminal 220 receives the public key authentication value notified by the vehicular terminal 100, from the user. In some embodiments, the public key authentication value from the user is received through the user input unit 230 or the sensing unit 240. When the public key authentication value is output in the form of an encoded frequency signal, the user terminal 200 directly receives the public key authentication value through the microphone module 222. The control unit 150 of the vehicular terminal 100 and the control unit 280 of the user terminal 200 may include codecs for converting a public key authentication value (digital) to a frequency signal (analog) or vice versa.

Next, in operation S570, a session between the vehicular terminal 100 and the user terminal 200 is generated by using a public key and a public key authentication value. Accordingly, the pairing of the vehicular terminal 100 and the user terminal 200 is terminated. In some embodiments, The vehicular terminal 100 and the user terminal 200 generates a session key to generate a session.

Meanwhile, in some embodiments, a database is provided in the storage unit 260 of the user terminal 200 while the database server 300 is not separately provided.

The method described in relation to the embodiments of the inventive concept may be implemented by a software module performed by a processor. The software module may reside in a random access memory (RAM), an ROM, an EPROM, an EEPROM, a flash memory, a register, a hard disk, a detachable disk, a CD-ROM, or a computer readable recording medium of an arbitrary form that is known in the technical field to which the inventive concept pertains.

According to the inventive concept, a vehicular terminal that requires pairing may be identified more easily through a screen of a user terminal.

Further, the pairing of the user terminal and the vehicular terminal may be simply, easily, and more intuitively performed.

Further, the pairing of the user terminal and the vehicular terminal may be performed more safely in security.

The aspect of the inventive concept is not limited thereto, and other unmentioned aspects of the inventive concept may be clearly appreciated by those skilled in the art from the following descriptions.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A method of pairing a vehicular terminal and a user terminal by using Beacon by the user terminal, the method comprising:
receiving a Beacon message from the vehicular terminal;
searching for a service corresponding to the received Beacon message;
displaying an object regarding the service on a screen; and
if the object is selected by a user, initiating pairing of the vehicular terminal and the user terminal.

2. The method of claim 1, wherein the searching for the service corresponding to the received Beacon message comprises:
transmitting a request for searching for a service to a database server and receiving a service search result from the database server.

3. The method of claim 1, further comprising:
searching for a paring record regarding the vehicular terminal; and
if there is not pairing record regarding the vehicular terminal, transmitting a request for pairing to the vehicular terminal.

4. The method of claim 3, wherein the searching for the paring record regarding the vehicular terminal comprises:
transmitting a request for searching for a pairing record to a database server and receiving a pairing record search result from the database server.

5. The method of claim 1, wherein the initiating of the pairing of the vehicular terminal and the user terminal comprises:
if the object is selected by the user, providing a connection management menu for a connection of the vehicular terminal; and
if a connection to the vehicular terminal is selected from the connection management menu by the user, initiating paring of the vehicular vehicle and the user terminal.

6. The method of claim 1, further comprising:
transmitting a request for pairing to the vehicular terminal;
exchanging public keys with the vehicular terminal; and
receiving a public key authentication value that is notified by the vehicular terminal, from the user.

7. The method of claim 6, wherein the public key authentication value is notified in a form of a text, an image, a voice, or a frequency signal.

8. The method of claim 6, further comprising:
generating a session with the vehicular terminal by using the public key and the public key authentication value.

9. The method of claim 8, wherein the vehicular terminal is a vehicular on-board diagnostics (OBD) terminal, and
the searching for the service comprises:
searching a database for information of the vehicular OBD terminal corresponding to the received Beacon message.

10. A vehicular terminal comprising:
a wireless communication unit that wirelessly communicates with a user terminal;
an output unit that notifies a user of information; and
a control unit that controls the wireless communication unit and the output unit to pair the vehicular terminal and the user terminal,
wherein the pairing of the vehicular terminal and the user terminal comprises:
transmitting a Beacon message to the user terminal;
receiving a request for pairing from the user terminal;
exchanging public keys with the user terminal; and
notifying the user of a public key authentication value.

11. The vehicular terminal of claim 10, wherein the public key authentication value is notified in a form of a text, an image, a voice, or a frequency signal.

12. The vehicular terminal of claim 10, further comprising:
a vehicular communication unit that communicates with at least one element in a vehicle.
